(19) United States
(12) Patent Application Publication
(10) Pub. No.: US 2026/0321168 A1
(43) Pub. Date: Oct. 15, 2026

(54) BOX WITH DISPLAY DEVICE

(71) Applicant: Iris Optronics Co., Ltd., Tainan City (TW)

(72) Inventors: Cheng Yu LIN, Kaohsiung City (TW); Cheng Hong YAO, Tainan City (TW); Chi Chang LIAO, Tainan City (TW)

(21) Appl. No.: 19/415,818

(22) Filed: Dec. 11, 2025

(30) Foreign Application Priority Data
Apr. 15, 2025 (TW) 114114119

(51) Int. Cl. G09F 21/04; G02F 1/01; G02F 1/13; G02F 1/133

(52) U.S. Cl. CPC G09F 21/048; G02F 1/0121; G02F 1/1313; G02F 1/13324; G09F 21/041; G02F 2201/465

(57) ABSTRACT

A box with a display device includes a mobile box, a display device, and a control board. The display device is configured to display at least one advertisement data. The control board is signal-connected to the display device and includes a positioning module and a communication module. The positioning module is configured to provide a location data of the display device. The communication module is signal-connected to the positioning module and configured to upload the location data to a cloud server. The cloud server is configured to store the at least one advertisement data corresponding to at least one region, and based on the location data, the cloud server transmits the at least one advertisement data corresponding to the at least one region to the communication module, such that the at least one advertisement data is displayed on the display device.

### RELATED APPLICATIONS

This application claims priority to Taiwan Application Serial Number 114114119, filed Apr. 15, 2025, which is herein incorporated by reference.

### BACKGROUND

### Technical Field

The present disclosure relates to a box with a display device.

### Description of Related Art

Existing billboards in the prior art cannot update advertising content in real-time and primarily rely on manual replacement of images or text, which not only results in cumbersome operational procedures but also incurs high production and replacement costs, thereby making frequent updates of advertising data unfeasible.

Moreover, most electronic billboards rely on external power sources for powering and cannot operate detached from a stationary power supply system. Consequently, such billboards are usually installable solely at specific locations, such as exterior walls of buildings, entrances/exits of large shopping malls, or major transportation nodes. Due to the high installation and maintenance costs of such billboards, their deployed quantities are limited, making it difficult to form a widely distributed advertising network and even more challenging to conduct dynamic promotions targeting specific pedestrian flow routes or regions, consequently reducing their appeal for transient or short-term events.

For instance, when a department store conducts anniversary promotions, if advertisements are solely displayed at entrances/exits, the attracted crowd is confined to those within the field of view, making it difficult to access potential customers in peripheral areas, thereby restricting overall advertising efficacy. If it is desired to enhance the exposure intensity of an event, substantial advertising resources are often required to be utilized for reinforcement, consequently incurring a significant increase in the cost expenditure structure. Therefore, the industry urgently requires an advertising display device capable of dynamically adjusting content in response to regional variations, thereby enabling advertising data to be updated in real time according to location or temporal factors, thus effectively enhancing the advertisement reach and overall promotional effectiveness.

### SUMMARY

According to one aspect of the present disclosure, a box with a display device includes a mobile box, a display device, and a control board. The mobile box includes a surface. The display device is disposed on the surface. The display device is configured to display at least one advertisement data. The control board is signal-connected to the display device and includes a positioning module and a communication module. The positioning module is configured to provide a location data of the display device. The communication module is signal-connected to the positioning module and configured to upload the location data to a cloud server. The cloud server is configured to store the at least one advertisement data corresponding to at least one region, and based on the location data, the cloud server transmits the at least one advertisement data corresponding to the at least one region to the communication module, such that the at least one advertisement data is displayed on the display device.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a box with a display device, installed on a mobile carrier, according to a first embodiment of the present disclosure.

FIG. 2 is a block diagram of the box with the display device according to the first embodiment of the present disclosure.

FIG. 3 is a three-dimensional exploded view of a mobile box, a display device, and an adhesive layer in the box with the display device according to the first embodiment of the present disclosure.

FIG. 4 is a three-dimensional exploded view of a mobile box and a display device in a box with a display device according to a second embodiment of the present disclosure.

FIG. 5 is a three-dimensional exploded view of a mobile box and a display device in a box with a display device according to a third embodiment of the present disclosure.

FIG. 6 is a three-dimensional exploded view of a mobile box and a display device in a box with a display device according to a fourth embodiment of the present disclosure.

FIG. 7 is a three-dimensional exploded view of a mobile box and a display device in a box with a display device according to a fifth embodiment of the present disclosure.

FIG. 8 is a three-dimensional view of a box with a display device, used with an electronic device, according a sixth embodiment of the present disclosure.

FIG. 9 is a block diagram of a box with a display device according to a seventh embodiment of the present disclosure.

### DETAILED DESCRIPTION

A plurality of embodiments of the present disclosure will be described below with reference to the drawings. For the sake of clarity, many practical details will be described together in the following description. However, it should be understood that these practical details are not intended to limit the present disclosure. That is, in some embodiments of the present disclosure, these practical details are not necessary. Additionally, to simplify the drawings, some conventional structures and components are depicted in the drawings in a simplified schematic manner; and repeated components may be represented by the same reference numerals.

In addition, when a certain component (or unit or module, etc.) is "connected/linked" to a further component herein, it may mean that the component is directly connected/linked to the further component, or that the certain component is indirectly connected/linked to the further component, that is, there are other components between the component and the further component. When it is explicitly stated that a certain component is "directly connected/linked" to a further component, it means that there are no other components between the component and the further component. The terms "first," "second," and "third", etc. are merely used to describe different components but do not limit the components themselves. Therefore, a first component may also be referred to as a second component. Furthermore, combinations of components/units/circuits herein are not well-known, conventional, or obvious combinations in the art, and it cannot be determined , based solely on whether the components/units/circuits themselves are conventional, whether their combinations can be easily accomplished by a person of ordinary skill in the art.

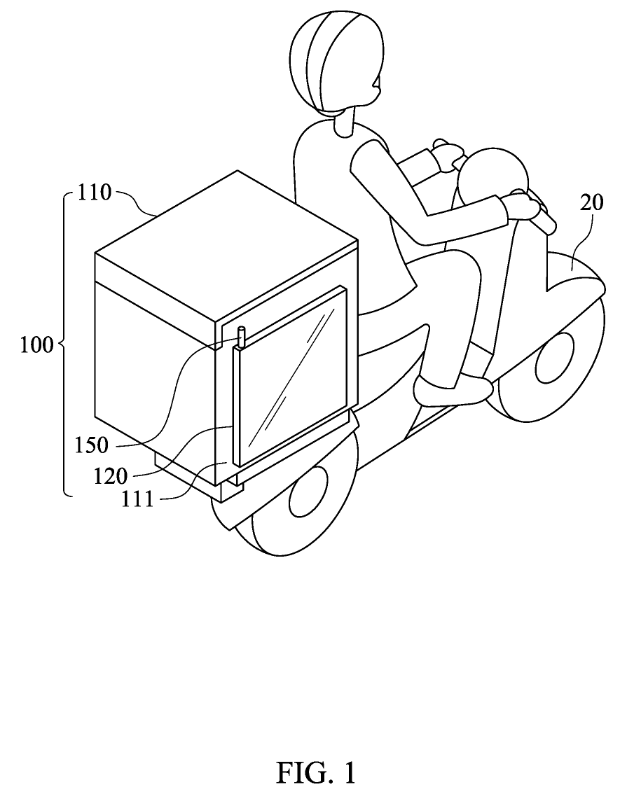

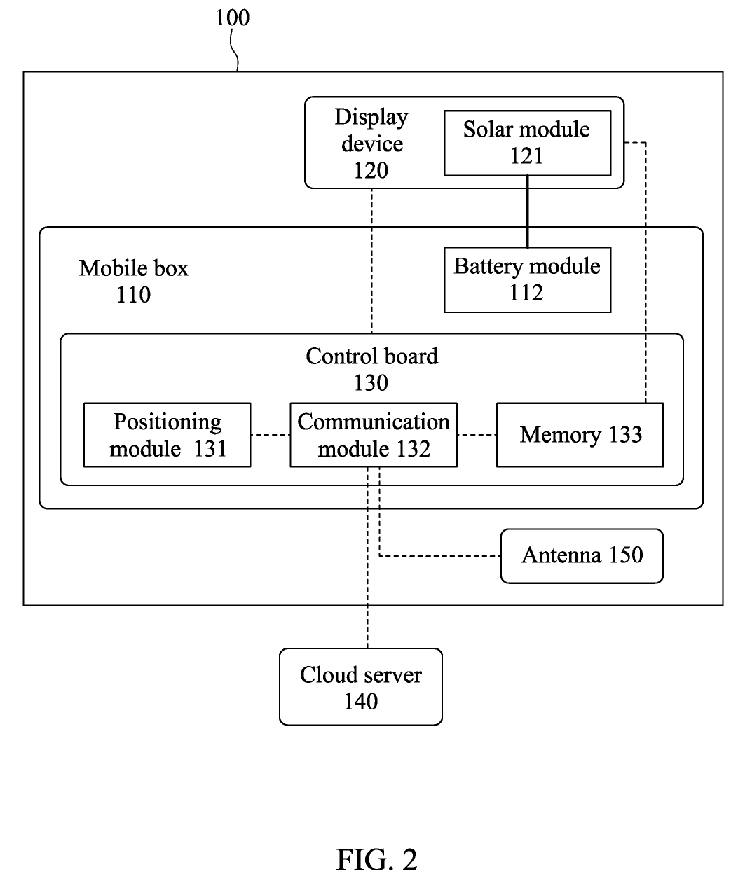

Reference is made to FIGS. 1 and 2, where FIG. 1 is a schematic diagram of a box with a display device, installed on a mobile carrier, according to a first embodiment of the present disclosure; and FIG. 2 is a block diagram of the box with the display device according to the first embodiment of the present disclosure. As shown in FIGS. 1 and 2, a box 100 with a display device includes a mobile box 110, a display device 120 and a control board 130. The mobile box 110 has a surface 111, the display device 120 is disposed on the surface 111 and displays at least one advertisement data, and the control board 130 is disposed at the mobile box 110 and signal-connected to the display device 120. In the first embodiment, the mobile box 110 is installed on a mobile carrier 20 (i.e., a haulage motor) and is movable along with the travel of the mobile carrier 20, but is not limited thereto. In other embodiments, the mobile box can be moved by being carried on the back of a person, or can be installed on a bicycle, a cart, a logistics transport vehicle, or other carriers with mobility functions. The advertisement data refers to advertising content that can be played by the display device 120, the form of which may include, but is not limited to, images, text, audio/video, etc., for presenting commercial promotions, brand promotions, event data, or other related content.

The display device 120 may be a cholesteric liquid crystal display (ChLCD), but is not limited thereto. The principle of the ChLCD is to use a specially arranged liquid crystal structure to reflect light of a specific color, enabling screen display without backlighting. Therefore, the ChLCD has the characteristics of high color saturation, low power consumption, and resistance to ambient light interference, etc., but is not limited to thereto. In other embodiments, the display device may further be an e-ink display.

The control board 130 includes a positioning module 131 and a communication module 132. The positioning module 131 is a global positioning system (GPS), which is configured to provide a location data of the display device 120. The communication module 132 is signal-connected to the positioning module 131, and can upload the obtained location data to a cloud server 140 via wireless transmission, such as 4th Generation Mobile Communication (4G), 5th Generation Mobile Communication (5G), or Wireless Fidelity (Wi-Fi). The cloud server 140 stores the advertisement data corresponding to at least one region. Based on the location data, the cloud server transmits the advertisement data associated with the corresponding region to the communication module 132, such that the advertisement data is displayed on the display device 120. In other words, the cloud server 140 stores the advertisement data corresponding to different regions, and based on the received location data, automatically selects the advertisement data associated with the corresponding region and transmits the advertisement data back to the communication module 132. After receiving the advertisement data, the communication module 132 transmits the advertisement data to the display device 120 for display. In other embodiments, the server may also be located locally, enabling it to directly transmit stored local advertisement data to the communication module to improve transmission efficiency.

Accordingly, advertisement data corresponding to a surrounding region can be automatically switched and delivered based on different locations traveled through, thereby meeting localization-based advertisement demands.

It should be specifically noted that the number of the display device 120 is not limited to one. In other embodiments, two or more display devices may further be disposed on the mobile box, which are respectively disposed on different surfaces to expand a visible range or display different content according to advertising needs. For example, one display device may be provided on each of the left and right sides of the mobile box to simultaneously display the same or different advertisement data, thereby enhancing the promotional effect.

In the first embodiment, the ChLCD includes a substrate (not separately labeled) made of glass. The substrate made of glass is less prone to deformation, which helps to improve the clarity and stability of screen display and is suitable for displaying advertising content for a long time, but it is not limited thereto. In other embodiments, the substrate may also be made of a flexible material such as polyethylene terephthalate (PET) or polyimide (PI). Compared to the glass substrate, substrates made of PET and PI are lightweight, unbreakable, and highly flexible, etc., making them suitable for installation on uneven or curved surfaces. By leveraging these material characteristics, the durability of the display device on the mobile carrier can be enhanced, and the risk of damage caused by vibration or deformation can be reduced.

With reference to FIG. 2, the control board 130 may further include a memory 133. The memory 133 is signal-connected to the communication module 132 and the display device 120, and configured to receive and store the advertisement data transmitted by the communication module 132 for display on the display device 120. In other words, the memory 133 can be regarded as a temporary storage device, which can continuously supply pre-stored advertisement data to the display device 120 during wireless communication interruptions, weak signals, or unstable networks, thereby avoiding interruption or blanking of screens and ensuring uninterrupted advertisement data. In addition, the memory 133 can have different capacities selected according to actual application requirements. If multiple sets of advertisement data corresponding to different regions, time periods, or advertisers need to be stored, a large-capacity memory may be selected to facilitate switching or repeatedly displaying the multiple sets of advertisement data. If the application scope changes little or the frequency of data update is low, a small-capacity memory may be selected to achieve the purpose of reducing costs and power consumption.

With continued reference to FIGS. 1 and 2, the box 100 with the display device may further include an antenna 150. The antenna 150 is disposed on one side of the display device 120 and signal-connected to the communication module 132. The antenna 150 is configured to receive and transmit wireless communication signals, such as 4G, 5G, Wi-Fi, and GPS signals. By receiving the above signals via the antenna 150, the communication module 132 can obtain the location data of the display device 120 and upload the location data to the cloud server 140. The cloud server 140 selects and transmits back the advertisement data associated with the corresponding region based on the received location data. The communication module 132, after receiving the advertisement data, transmits the advertisement data to the display device 120 for display. In other embodiments, the antenna may also be embedded in the display device, or be disposed on the mobile box in different ways. The specific set location of the antenna may be adjusted based on actual installation spaces, structural configurations, or usage requirements.

The following describes a transmission and display process of the advertisement data in the first embodiment, explaining how the advertisement data is updated according to the location change and displayed on the display device 120.

The positioning module 131 in the control board 130 may detect the location of the display device 120 and transmit the obtained location data to the communication module 132. The communication module 132 transmits and receives wireless signals via the antenna 150 and uploads the location data to the cloud server 140 via wireless transmission. The cloud server 140, after receiving the location data, queries and obtains the advertisement data stored in the corresponding region, and transmits corresponding location data back to the communication module 132 via the antenna 150. The communication module 132, after receiving the location data, transmits the advertisement data to the memory 133 in the control board 130 for storage. The display device 120 may read the advertisement data from the memory 133 and play it on display screen of the display device 120.

With continued reference to FIG. 2, the mobile box 110 may further include a battery module 112. The display device 120 may include a solar module 121. The solar module 121 is electrically connected to the battery module 112 and configured to generate an electric power and store the electric power in the battery module 112. Specifically, the solar module 121 may perform power generation in a light environment. The generated electric power is first stored in the battery module 112, and then supplied by the battery module 112 to the display device 120 to ensure stable display functionality.

Moreover, the solar module 121 may be in the form of single crystal silicon, polycrystalline silicon or flexible solar panels, and its specific form may be adjusted according to factors such as actual installation space, weight restrictions and power generation efficiency. In the first embodiment, the solar module 121 is disposed around a housing of the display device 120, but is not limited thereto. In other embodiments, the solar module may also be disposed on the top of the display device or the top of the mobile box to effectively receive sunlight and improve power generation efficiency.

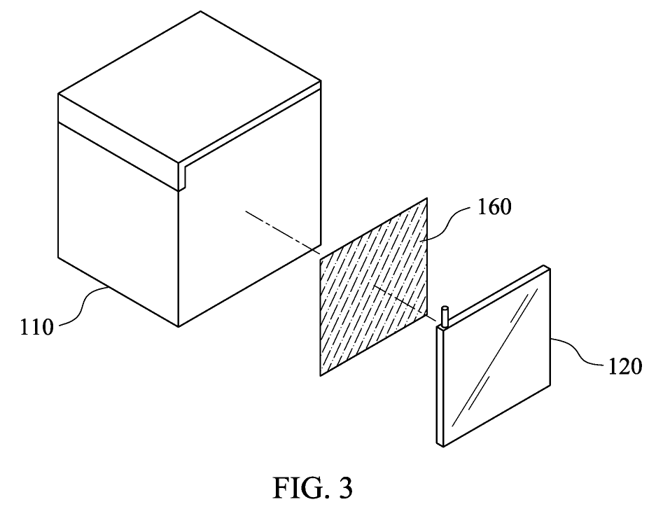

Reference is made to FIG. 3, where FIG. 3 is a three-dimensional exploded view of the mobile box, the display device, and an adhesive layer in the box with the display device according to the first embodiment of the present disclosure. The display device 120 may be connected to the mobile box 110 in different ways. In the first embodiment, the box 100 with the display device may further include an adhesive layer 160. The adhesive layer 160 is disposed on the mobile box 110 or the display device 120 and configured to adhere and fix the mobile box 110 and the display device 120. Specifically, the adhesive layer 160 may be made of double-sided tape, acrylic adhesive, hot melt adhesive, silicone adhesive, or other materials with adhesive properties. The material has good adhesion and flexibility, and accordingly can effectively fix the display device 120, and absorb external impact, thereby improving structural stability and durability. The adhesive layer 160 is used for bonding and fixing, which can also simplify the assembly process and reduce the use of mechanical components, thereby helping to reduce manufacturing costs and improve mass production efficiency.

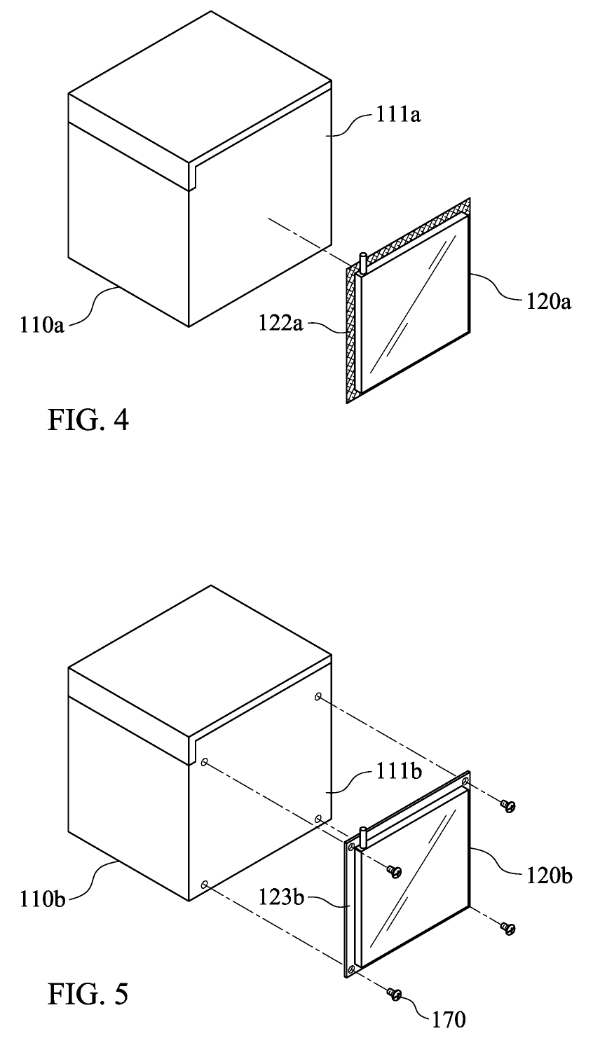

Reference is made to FIG. 4, where FIG. 4 is a three-dimensional exploded view of a mobile box and a display device in a box with a display device according to a second embodiment of the present disclosure. In FIG. 4, a difference between the second embodiment and the first embodiment mainly lies in the coupling manner between a mobile box 110a and a display device 120a. Specifically, in the second embodiment, the display device 120a is provided with a stitching portion 122a. The stitching portion 122a is stitched to a surface 111a so as to fix the display device 120a to the mobile box 110a.

This provides a secure and non-loosening fixing effect, which is particularly suitable for application scenarios where long-term installation on fabrics or flexible materials is required.

It must be noted that the remaining components and structural configuration of the box with the display device in the second embodiment are the same as or similar to those of the box 100 with the display device in the first embodiment, and thus will not be redundantly described herein.

Reference is made to FIG. 5, where FIG. 5 is a three-dimensional exploded view of a mobile box and a display device in a box with a display device according to a third embodiment of the present disclosure. In FIG. 5, a difference between the third embodiment and the first embodiment mainly lies in the coupling manner between a mobile box 110b and a display device 120b. Specifically, in the third embodiment, the display device 120b includes a locking portion 123b. The locking portion 123b is locked to a surface 111b by a plurality of locking members 170.

In this way, the locking portion 123b cooperating with the locking members 170 can provide a stable and detachable fixing effect, so that the display device 120b after being installed exhibits excellent structural stability, thereby facilitating future maintenance, replacement or reassembly.

It must be noted that the remaining components and structural configuration of the box with the display device in the third embodiment are the same as or similar to those of the box 100 with the display device in the first embodiment, and thus will not be redundantly described herein.

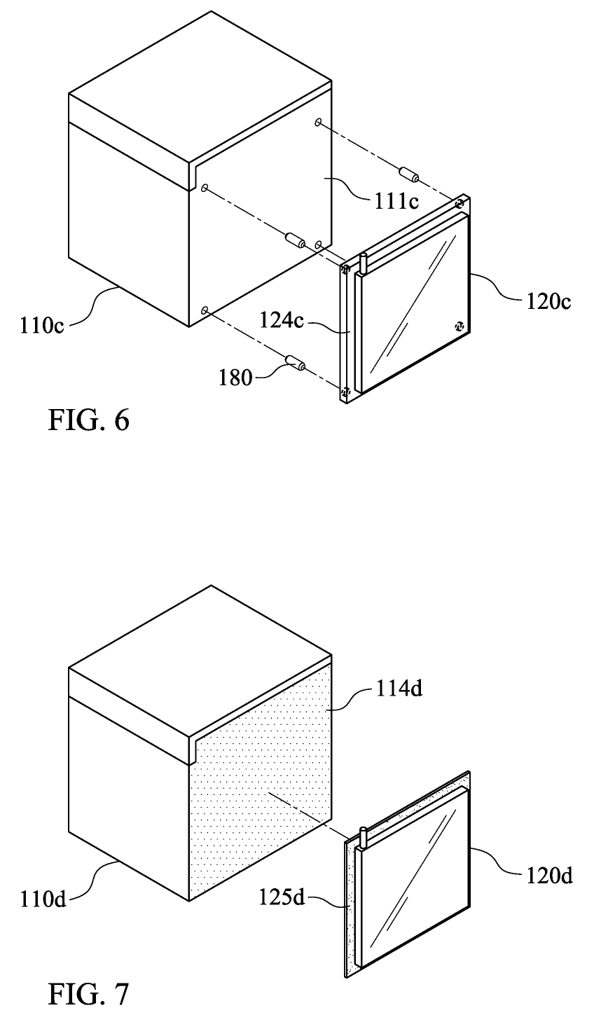

Reference is made to FIG. 6, where FIG. 6 is a three-dimensional exploded view of a mobile box and a display device in a box with a display device according to a fourth embodiment of the present disclosure. In FIG. 6, a difference between the fourth embodiment and the first embodiment mainly lies in the coupling manner between a mobile box 110c and a display device 120c. Specifically, in the fourth embodiment, the display device 120c includes a snap-fit portion 124c. The snap-fit portion 124c is snap-fitted to a surface 111c by a plurality of tenons 180.

In this way, the snap-fit portion 124c cooperating with the tenons 180 can provide a quick installation and disassembly structure, so that the display device 120c can be conveniently installed on the mobile box 110c without using additional tools. Such configuration helps improve the efficiency of installation work and facilitates future replacements and adjustments.

It must be noted that the remaining components and structural configuration of the box with the display device in the fourth embodiment are the same as or similar to those of the box 100 with the display device in the first embodiment, and thus will not be redundantly described herein.

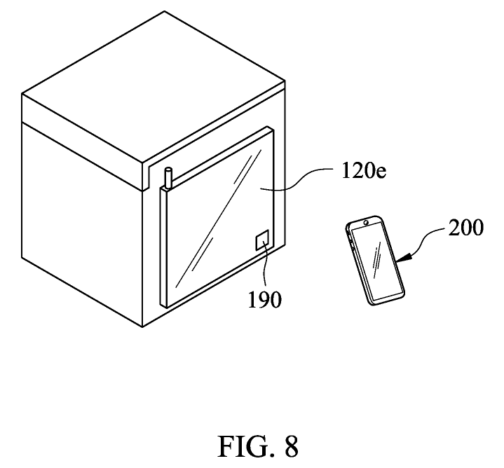

Reference is made to FIG. 7, where FIG. 7 is a three-dimensional exploded view of a mobile box and a display device in a box with a display device according to a fifth embodiment of the present disclosure. In FIG. 7, a difference between the fifth embodiment and the first embodiment mainly lies in the coupling manner between a mobile box 110d and a display device 120d. Specifically, in the fifth embodiment, the display device 120d includes a magnetic attraction portion 125d. A surface of the mobile box 110d is a magnetic attraction surface 114d. The magnetic attraction portion 125d is magnetically connected to the magnetic attraction surface 114d.

In this way, the magnetic attraction portion 125d can be directly attracted to the magnetic attraction surface 114d, so as to achieve the purpose of tool-free quick installation and removal. Such magnetic attraction structure offers excellent convenience and reusability, and thus is suitable for applications that require frequent assembly and disassembly, or installation location switching between different mobile carriers.

It must be noted that the remaining components and structural configuration of the box with the display device in the fifth embodiment are the same as or similar to those of the box 100 with the display device in the first embodiment, and thus will not be redundantly described herein.

FIG. 8 is a three-dimensional view of a box with a display device, used with an electronic device according a sixth embodiment of the present disclosure. In the sixth embodiment, advertisement data displayed by a display device 120e includes an identification tag 190 for being read by an electronic device 200. The electronic device 200 may be a smart phone, but is not limited thereto. In other embodiments, the electronic device may also be a device with a reading function, such as a tablet computer or other mobile devices.

A user scans the identification tag 190 in the advertisement data through the electronic device 200 to read data content contained therein. The identification tag 190 may be implemented as textual links, images, barcodes, two-dimensional codes, or any other recognizable tag format. Upon successful identification by the electronic device 200, the user may be directed to access corresponding data.

The data included in the identification tag 190 may include a restaurant data, a reservation data, a discount data, a review data, a social media link data, an event promotion data, a recommended menu data, or any combinations thereof. By setting the identification tag 190, more extended data can be provided to the user, which further enhances the interactivity of the advertising content.

It must be noted that the remaining components and structural configuration of the box with the display device in the sixth embodiment are the same as or similar to those of the box 100 with the display device in the first embodiment, and thus will not be redundantly described herein.

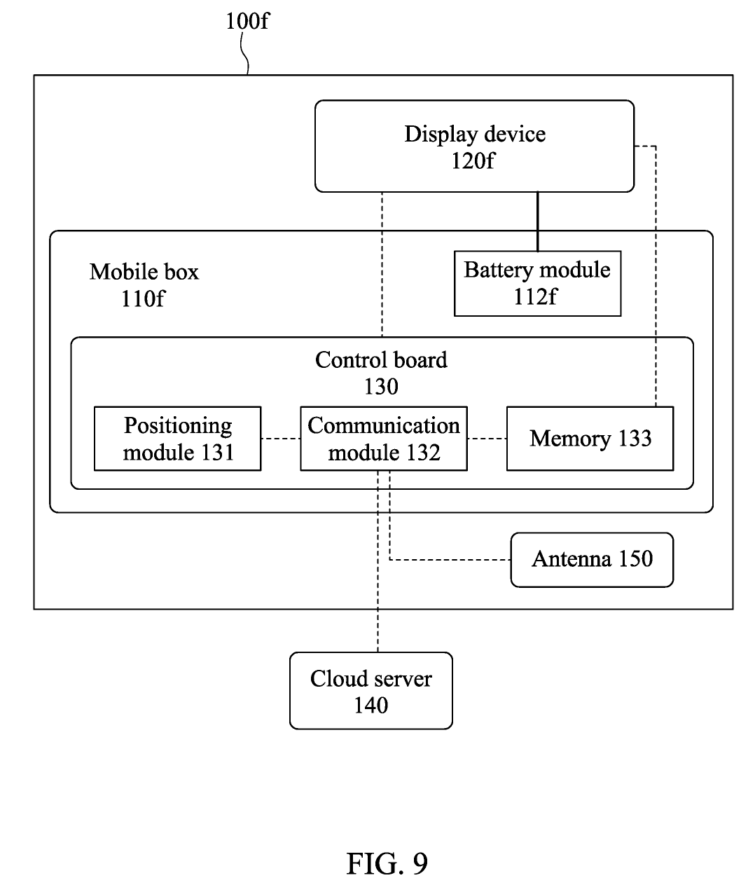

Reference is made to FIG. 9, where FIG. 9 is a block diagram of a box with a display device according to a seventh embodiment of the present disclosure. In the seventh embodiment, a mobile box 110f includes a battery module 112f. The battery module 112f is electrically connected to the display device 120f and serves as a stable power source. Differing from the first embodiment, the display device 120f in the seventh embodiment does not include a solar module, but is connected to the battery module 112f through wires or connectors to obtain power.

It must be noted that the remaining components and structural configuration of the box with the display device in the seventh embodiment are the same as or similar to those of the box 100 with the display device in the first embodiment, and thus will not be redundantly described herein.

In summary, the box with the display device of the present disclosure has the following advantages: first, the advertisement reach and overall promotional effectiveness can be enhanced; second, advertisement data corresponding to a surrounding region can be automatically switched and delivered, thereby meeting localization-based advertisement demands; and third, the advertisement data can be combined with an interactive identification tag, so that consumers scan and link to the restaurant data, etc. through the electronic device, thereby further improving advertising interactivity and introducing efficiency.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A box with a display device, comprising:
a mobile box comprising a surface;
a display device disposed on the surface, the display device configured to display at least one advertisement data; and
a control board, signal-connected to the display device, and comprising:
a positioning module, configured to provide a location data of the display device; and
a communication module, signal-connected to the positioning module, and configured to upload the location data to a cloud server, wherein the cloud server is configured to store the at least one advertisement data corresponding to at least one region, and based on the location data, the cloud server transmits the at least one advertisement data corresponding to the at least one region to the communication module, such that the at least one advertisement data is displayed on the display device.

2. The box with the display device according to claim 1, wherein the control board further comprises a memory signal-connected to the communication module and the display device, and the control board is configured to receive and store the at least one advertisement data from the communication module and enable the stored at least one advertisement data to be displayed by the display device.

3. The box with the display device according to claim 1, further comprising:
an antenna disposed on one side of the display device and signal-connected to the communication module.

4. The box with the display device according to claim 1, wherein the display device is a cholesteric liquid crystal display or an e-ink display.

5. The box with the display device according to claim 4, wherein when the display device is the cholesteric liquid crystal display, and the display device comprises a substrate made of glass, polyethylene terephthalate or polyimide.

6. The box with the display device according to claim 1, wherein
the mobile box comprises a battery module; and
the display device comprises a solar module electrically connected to the battery module and configured to generate an electric power to be stored in the battery module.

7. The box with the display device according to claim 1, wherein the mobile box comprises a battery module electrically connected to the display device.

8. The box with the display device according to claim 1, further comprising:
an adhesive layer disposed on the mobile box or the display device, the adhesive layer configured to adhere the mobile box and the display device.

9. The box with the display device according to claim 1, wherein the display device comprises a stitching portion stitched to the surface.

10. The box with the display device according to claim 1, wherein the display device comprises a locking portion locked to the surface by a plurality of locking members.

11. The box with the display device according to claim 1, wherein the display device comprises a snap-fit portion snap-fitted to the surface by a plurality of tenons.

12. The box with the display device according to claim 1, wherein
the display device comprises a magnetic attraction portion; and
the surface of the mobile box is a magnetic attraction surface, and the magnetic attraction portion is magnetically connected to the magnetic attraction surface.

13. The box with the display device according to claim 1, wherein the at least one advertisement data comprises an identification tag configured to be read by an electronic device.

14. The box with the display device according to claim 13, wherein the identification tag comprises at least one of a restaurant data, a reservation data, a discount data, a review data, a social media link data, an event promotion data, a recommended menu data, and combinations thereof.
